(19) United States
(12) Patent Application Publication
(10) Pub. No.: US 2025/0237931 A1
(43) Pub. Date: Jul. 24, 2025

(54) ELECTRONIC APPARATUS AND ITS MANUFACTURING METHOD

(71) Applicant: CANON KABUSHIKI KAISHA, Tokyo (JP)

(72) Inventors: SHIN ITAGAKI, Tokyo (JP); AKINORI INAGAKI, Tokyo (JP)

(21) Appl. No.: 18/969,678

(22) Filed: Dec. 5, 2024

(30) Foreign Application Priority Data
Jan. 22, 2024 (JP) 2024-007115

(51) Int. Cl. G03B 17/08

(52) U.S. Cl. CPC G03B 17/08

(57) ABSTRACT

An electronic apparatus includes an elastic member, a compression member that compresses the elastic member, and an attachment member having a groove in which the elastic member is disposed and an overlap portion that overlaps a part of the groove when viewed from a compression direction of the compression member. A part of the elastic member seals a gap between the attachment member and the compression member. Another part of the elastic member is disposed between the groove and the overlap portion.

### BACKGROUND

### Technical Field

The present disclosure relates generally to an electronic apparatus, such as a digital camera and a digital video camera, and more particularly to a drip-proof structure for a connection portion between components.

### Description of Related Art

Conventionally, liquid gaskets such as UV-cured gaskets have been used for a drip-proof configuration for an exterior cover. Japanese Patent Laid-Open No. 2021-055706 discloses a configuration in which a gasket made of a sealant that has been applied along a groove formed in a first member and then cured, a protrusion portion provided to a second member is pressed into the gasket, and the first member and the second member are joined together.

Recently, Japan SDGs Action Platform “Responsibility to Produce and Responsibility to Use” has asserted the right of equipment users to repair products without using the manufacturer, and therefore demanded improved reworkability. However, in the configuration of Japanese Patent Laid-Open No. 2021-055706, in the case of large tackiness, it is not clear from which of the first member and the second member the gasket will peel off in disassembling the first member and the second member. In a case where it does not peel off on the desired side, reassembly is difficult and reworkability is impaired. Therefore, it is difficult to apply the configuration of Japanese Patent Laid-Open No. 2021-055706 to locations that are frequently reworked.

### SUMMARY

An electronic apparatus according to one aspect of the disclosure includes an elastic member, a compression member that compresses the elastic member, and an attachment member having a groove in which the elastic member is disposed and an overlap portion that overlaps a part of the groove when viewed from a compression direction of the compression member. A part of the elastic member seals a gap between the attachment member and the compression member. Another part of the elastic member is disposed between the groove and the overlap portion. Alternatively, the overlap portion may be a member separate from the attachment member.

A method according to another aspect of the disclosure for manufacturing an electronic apparatus that includes an elastic member, a compression member that compresses the elastic member, and an attachment member having a groove in which the elastic member is disposed and an overlap portion that overlaps a part of the groove when viewed from a compression direction of the compression member includes the steps of disposing the elastic member in the groove such that a part of the elastic member is disposed in a portion of the groove that corresponds to the overlap portion, and compressing another part of the elastic member with the compression member so as to seal a gap between the attachment member and the compression member.

Further features of various embodiments of the disclosure will become apparent from the following description of embodiments with reference to the attached drawings.

### BRIEF DESCRIPTION OF THE DRAWINGS

FIGS. 1A, 1B, and 1C are external views of a digital single-lens reflex camera, which is an example electronic apparatus according to this embodiment of the present disclosure.

FIG. 2 illustrates an example configuration around a viewfinder.

FIG. 3 corresponds to FIG. 2 from which an exterior cover is removed.

FIG. 4 is a schematic sectional view illustrating an example in which a viewfinder cover and a viewfinder panel are integrated.

FIG. 5 illustrates another example configuration around the viewfinder.

FIG. 6 is a sectional view taken along a line B-B in FIG. 5.

FIG. 7 is a sectional view taken along a line C-C in FIG. 6.

FIGS. 8A, 8B, 8C, 8D, and 8E are schematic views illustrating a manufacturing process for the configuration around the viewfinder.

### DETAILED DESCRIPTION

Referring now to the accompanying drawings, a detailed description will be given of embodiments according to the disclosure. Corresponding elements in respective figures will be designated by the same reference numerals, and a duplicate description thereof will be omitted.

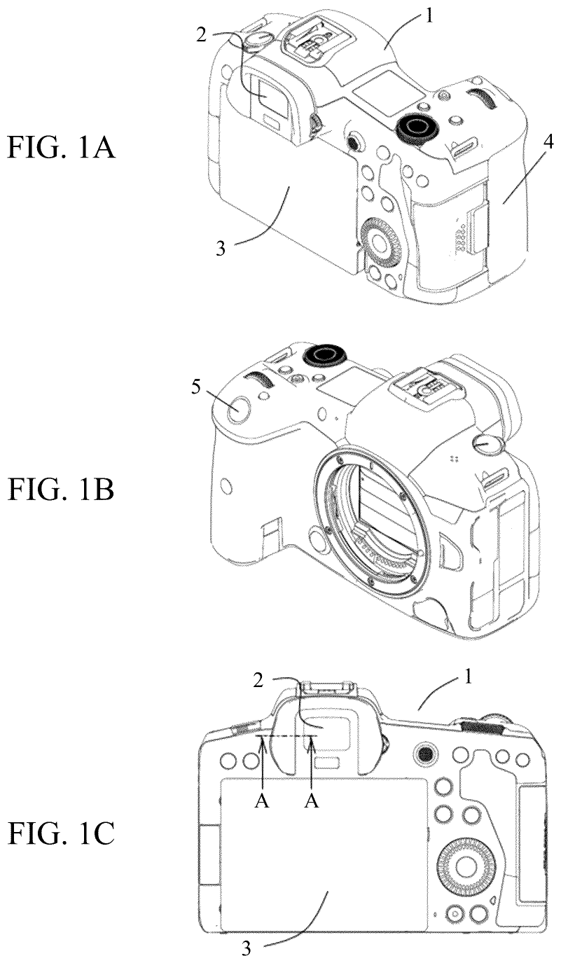

FIGS. 1A, 1B, and 1C are external views of a digital single-lens reflex camera 1 (referred to as camera 1 hereinafter), which is an example electronic apparatus according to this embodiment of the present disclosure. FIG. 1A is a perspective view of the camera 1 viewed from the rear side. FIG. 1B is a perspective view of the camera 1 viewed from the front side. FIG. 1C is a rear view of the camera 1. A viewfinder 2 enables a user to observe an object image formed through an unillustrated lens barrel and to determine a composition during imaging. A display apparatus 3 enables the user to check a captured image, etc. A grip portion 4 is held by a user during imaging, etc. A release button 5 is pressed down for imaging. The camera 1 detects the pressing of the release button 5, and controls the driving of an unillustrated image sensor, the operation of an image processing circuit, and the compression processing of a recording processing circuit, etc., to record the captured image.

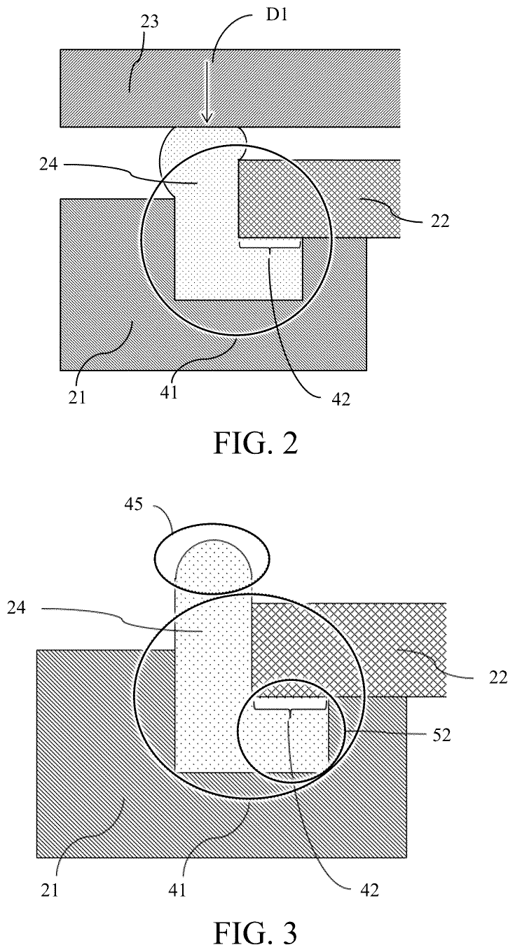

A description will now be given of a drip-proof structure around the viewfinder 2. FIG. 2 illustrates an example configuration around the viewfinder 2, and is a schematic sectional view of the viewfinder 2 around the viewfinder 2 in FIG. 1C taken along a line A-A. A viewfinder cover 21 and a viewfinder panel 22 are attachment members on which a seal member (elastic member) 24 is disposed. An exterior cover (compression member) 23 compresses the sealing member 24 in a direction (compression direction) D1 in FIG. 2. Compressing the sealing member 24 with the exterior cover 23 provides sealing, and prevents water from entering a gap between the viewfinder cover 21 and the exterior cover 23.

The viewfinder cover 21 and the viewfinder panel 22 also form a groove shape (groove) 41. The attachment member formed by the viewfinder cover 21 and the viewfinder panel 22 has an engagement shape (overlap portion) 42 that overlaps a part of the groove shape 41 when viewed from the direction D1. A part of the sealing member 24 is disposed between the groove shape 41 and the engagement shape 42. The sealing member 24 is a curable elastic member that is curable when a predetermined condition is applied, and is placed in the groove shape 41.

FIG. 3 corresponds to FIG. 2 in which the exterior cover 23 is removed, and illustrates a state before the sealing member 24 is compressed by the exterior cover 23. The sealing member 24 has an engaged portion 52 and a tip shape (sealing portion) 45. The engaged portion 52 is engaged by the engagement shape 42. Thereby, the sealing member 24 is prevented from peeling off from the groove shape 41. The tip shape 45 has a shape that is easily crushed when compressed by the exterior cover 23, and contributes to sealing between the viewfinder cover 21 and the exterior cover 23.

The sealing member 24 is a curable elastic member that is applied in a liquid state to the groove shape 41 and is curable by UV irradiation. Applying the sealing member 24 in a liquid state can fill the sealing member 24 more reliably in the engagement shape 42. Various complex groove shapes can be filled without requiring assembly labor. The sealing member 24 is a curable elastic member in this embodiment, but this embodiment is not limited to this example. The sealing member 24 may be, for example, another elastic member such as a rubber member.

The method of curing the sealing member 24 is not limited to the UV irradiation, and may be another method such as curing by two-component mixture, thermal curing by heating, curing by reaction with moisture, curing by drying, and solidification by cooling.

In removing the exterior cover 23, the sealing member 24 may adhere to the exterior cover 23 and come off the groove shape 41 because of its tackiness. This embodiment provides the engagement shape 42, enables the sealing member 24 (engaged portion 52) installed in the groove shape 41 to be hooked on the engagement shape 42, and prevented from peeling off from the groove shape 41.

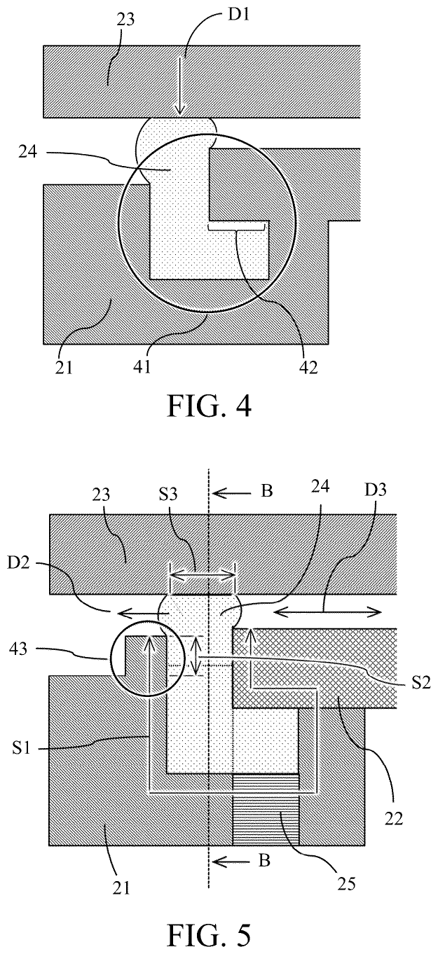

As illustrated in FIG. 4, as long as the sealing member 24 is curable after being applied to the groove shape 41, the viewfinder cover 21 and the viewfinder panel 22 may be integrated without being divided.

As described above, the configuration of this embodiment can provide an electronic apparatus having a drip-proof configuration that reduces peeling of the curable elastic member from the applied member and improves reworkability.

FIG. 5 illustrates another example configuration around the viewfinder 2. A UV light transmitting member 25 is an applied member that transmits UV light. Since at least part of the applied member is made of a material that transmits UV light, a range in which UV light can be irradiated is expanded, so that the curing of the sealing member 24 can be promoted and the process time can be reduced. A similar effect can be obtained even if the viewfinder panel 22 is made of a material that transmits UV light.

The viewfinder cover 21 may have a wall shape (extension portion) 43 that extends toward the exterior cover 23, for example, in the compression direction of the exterior cover 23. The extending direction of the wall shape is not limited to the compression direction. Thereby, the sealing member 24 can be prevented from spreading in a direction D2 caused by compression by the exterior cover 23, so that the sealing member 24 can be stably crushed and the sealing performance can be improved. Therefore, the intrusion of water from the gap between the viewfinder cover 21 and the exterior cover 23 can be further suppressed. The wall shape 43 can increase the adhesion area of the sealing member 24 by the range S2, and further suppress the peeling of the sealing member 24 from the groove shape 41.

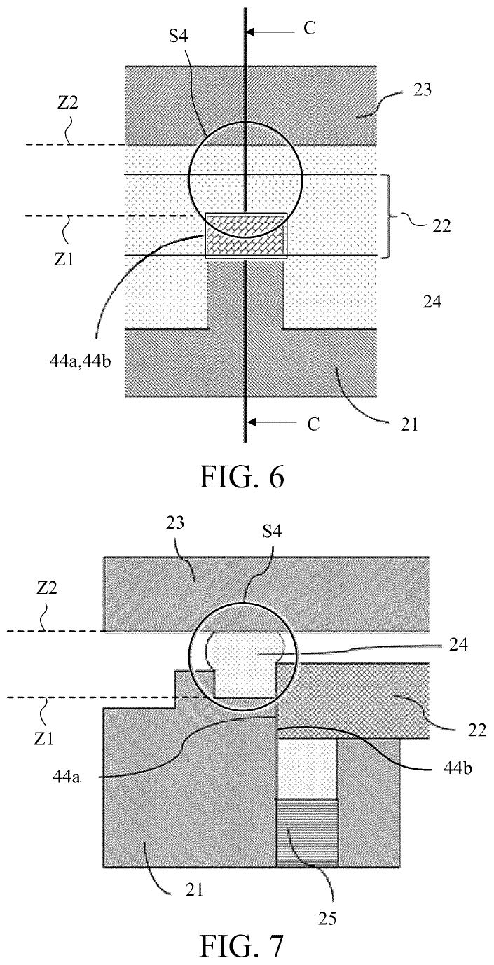

FIG. 6 is a sectional view taken along a line B-B in FIG. 5. FIG. 7 is a sectional view taken along a line C-C in FIG. 6. The viewfinder cover 21 and the viewfinder panel 22 may each have a first contact portion 44a and a second contact portion 44b parallel to the direction D1 in FIG. 2 in order to regulate their relative positions in a direction D3 in FIG. 5. Thereby, the groove shape 41 can be stably configured. The “parallel to the direction D1 in FIG. 2” includes not only “strictly parallel,” but also “substantially parallel (approximately parallel).”

In the direction DI in FIG. 2, an upper end Z2 of the sealing member 24 (the position where it contacts the exterior cover 23) may be disposed on the exterior cover 23 side of an upper end Z1 between the first contact portion 44a and the second contact portion 44b (the end position on the exterior cover 23 side of an area where the two contact portions contact each other). Thereby, the installation of the sealing member 24 can be continuous in a range S4 between the upper end Z1 between the first contact portion 44a and the second contact portion 44b and the exterior cover 23, as illustrated in FIG. 7. Therefore, the sealing member 24 can be continuously filled between the viewfinder cover 21 and the exterior cover 23, and water can be further prevented from entering the gap between the viewfinder cover 21 and the exterior cover 23.

A range S1 illustrated in FIG. 5 where the viewfinder cover 21 or the viewfinder panel 22 contacts the sealing member 24 may be given hydrophilicity by applying hydrophilic processing such as fine shape or coating. Thereby, the adhesive strength of the sealing member 24 increases. An area S3 where the exterior cover 23 can contact the sealing member 24, as illustrated in FIG. 5, may be given water-repellency by applying a water-repellent treatment such as a fine shape or coating. Thereby, the tackiness of the sealing member 24 to the exterior cover 23 can be reduced.

Such hydrophilicity or water-repellency can further prevent the sealing member 24 from peeling off from the viewfinder cover 21.

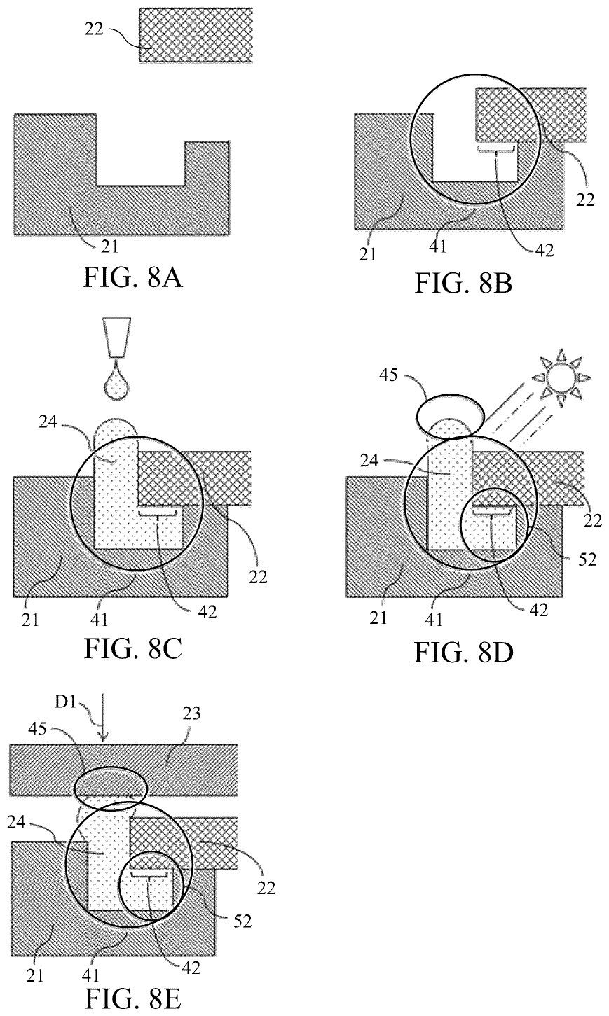

A description will be given of the manufacturing process of the configuration around the viewfinder 2. FIGS. 8A, 8B, 8C, 8D, and 8E are schematic diagrams illustrating the manufacturing process of the configuration around the viewfinder 2. First, as illustrated in FIGS. 8A and 8B, the viewfinder panel 22 is aligned and positioned with respect to the viewfinder cover 21. Thereby, the groove shape 41 and the engagement shape 42 are formed. Next, as illustrated in FIG. 8C, the sealing member 24 is applied to the groove shape 41 formed in FIG. 8B such that a part of the elastic member is disposed in a portion of the groove that corresponds to the overlap portion. Next, as illustrated in FIG. 8D, the sealing member 24 is irradiated with UV light to cure the sealing member 24 and adhere it to the groove shape 41. Thereby, the sealing member 24 is engaged with the engagement shape 42, and a tip shape 45 is formed. Finally, as illustrated in FIG. 8E, the tip shape 45 is compressed in the direction DI by the exterior cover 23. Thus, applying the sealing member 24 after the groove shape 41 and the engagement shape 42 are formed with a plurality of parts can simplify the application process and improve the sealing performance of the sealing member 24.

While the disclosure has described example embodiments, it is to be understood that the disclosure is not limited to the example embodiments. The scope of the following claims is to be accorded the broadest interpretation so as to encompass all such modifications and equivalent structures and functions. For example, the overlap portion may be a member separate from the attachment member.

This embodiment can provide an electronic apparatus that can improve reworkability.

This application claims priority to Japanese Patent Application No. 2024-007115, which was filed on Jan. 22, 2024, and which is hereby incorporated by reference herein in its entirety.

What is claimed is:

1. An electronic apparatus comprising:
an elastic member;
a compression member that compresses the elastic member; and
an attachment member having a groove in which the elastic member is disposed and an overlap portion that overlaps a part of the groove when viewed from a compression direction of the compression member,
wherein a part of the elastic member seals a gap between the attachment member and the compression member, and
wherein another part of the elastic member is disposed between the groove and the overlap portion.

2. The electronic apparatus according to claim 1, wherein the elastic member has been cured with elasticity under a predetermined condition.

3. The electronic apparatus according to claim 2, wherein the predetermined condition is UV irradiation, and
wherein at least a part of the attachment member transmits UV light.

4. The electronic apparatus according to claim 1, wherein the attachment member includes an extension portion that prevents the elastic member from spreading.

5. The electronic apparatus according to claim 1, wherein the attachment member includes a first member including a first contact portion parallel to the compression direction, and a second member including a second contact portion that is parallel to the compression direction and contacts the first contact portion.

6. The electronic apparatus according to claim 5, wherein in the compression direction, a position where the elastic member that contacts the compression member is disposed on a compression member side of an area where the first contact portion and the second contact portion contact each other.

7. The electronic apparatus according to claim 5, wherein the electronic apparatus is an image pickup apparatus having a viewfinder,
wherein the first member is a viewfinder cover, and
wherein the second member is a viewfinder panel.

8. The electronic apparatus according to claim 1, wherein the attachment member has a hydrophilic area that contacts the elastic member.

9. The electronic apparatus according to claim 1, wherein the compression member has a water-repellent area that contacts the elastic member.

10. The electronic apparatus according to claim 1, wherein the overlap portion suppresses peeling off of the elastic member when the compression member is removed.

11. The electronic apparatus according to claim 1, wherein the elastic member includes a sealing portion configured to seal the gap between the attachment member and the compression member while the elastic member is compressed by the compression member, and an engaged portion engaged with the overlap portion when the compression member is removed.

12. A method for manufacturing an electronic apparatus that includes an elastic member, a compression member that compresses the elastic member, and an attachment member having a groove in which the elastic member is disposed and an overlap portion that overlaps a part of the groove when viewed from a compression direction of the compression member, the method comprising the steps of:
disposing the elastic member in the groove such that a part of the elastic member is disposed in a portion of the groove that corresponds to the overlap portion; and
compressing another part of the elastic member with the compression member so as to seal a gap between the attachment member and the compression member.

13. An electronic apparatus comprising:
an elastic member;
a compression member that compresses the elastic member;
an attachment member having a groove in which the elastic member is disposed; and
an overlap portion that overlaps a part of the groove when viewed from a compression direction of the compression member,
wherein a part of the elastic member seals a gap between the attachment member and the compression member, and
wherein another part of the elastic member is disposed between the groove and the overlap portion.
